(19) United States
(12) Patent Application Publication
(10) Pub. No.: US 2023/0142343 A1
(43) Pub. Date: May 11, 2023

(54) REMOVAL OF RESIDUAL MERCAPTANS FROM POLYMER COMPOSITIONS

(71) Applicant: Arkema Inc., King of Prussia, PA (US)

(72) Inventor: Sangwoo PARK, King of Prussia, PA (US)

(21) Appl. No.: 17/918,586

(22) PCT Filed: Jun. 1, 2021
(86) PCT No.: PCT/US21/35090

§ 371 Date: Oct. 13, 2022

Related U.S. Application Data
(60) Provisional application No. 63/037,041, filed on Jun. 10, 2020.

(51) Int. Cl. C08G 81/02

(52) U.S. Cl. CPC C08G 81/025

(57) ABSTRACT

The removal of mercaptans from polymer compositions is described, where removal occurs by at least one of: contacting the polymer composition with a radical initiator that reacts with the mercaptain compound to form a non-odorous compound; and contacting the polymer composition with a transition metal that immobilizes the mercaptan compound.

### FIELD OF THE INVENTION

The present invention relates to the removal of mercaptans from polymer compositions.

### BACKGROUND OF THE INVENTION

Mercaptans are well known chain transfer agents employed in the manufacture of various polymers. The use of mercaptans allows for control of the polymeric chain length which affects the mechanical and processing properties of the resulting polymer. In view of the difficulty associated with removal of residual mercaptan odors from the polymer product, many manufacturers instead use non-mercaptan chain transfer agents such as isopropyl alcohol (IPA). IPA use, however, typically requires steam stripping to remove the presence of residual volatile organic compounds (VOC) which is not cost effective compared to mercaptan removal.

The present invention addresses the need for an improved technique for removal of residual mercaptan odors from polymer compositions by providing a cost effective chemical process and physical process that are used either separately or in combination to eliminate the use of steam stripping.

### SUMMARY OF THE INVENTION

Embodiments of the present invention relate to a method for removing a mercaptan compound present in a polymer composition, comprising at least one of: contacting the polymer composition with a radical initiator that reacts with the mercaptan compound to form a non-odorous compound; and contacting the polymer composition with a transition metal that immobilizes the mercaptan compound.

Embodiments of the present invention also relate to a method for removing a mercaptan compound present in a polymer, comprising at least one of: contacting the polymer with a radical initiator that reacts with the mercaptan compound to form a non-odorous compound; and contacting the polymer with a transition metal that immobilizes the mercaptan compound.

### BRIEF DESCRIPTION OF THE DRAWINGS

The following drawings illustrate particular embodiments of the present invention but are not intended to limit the scope of the invention as described herein.

FIG. 1 depicts the physical immobilization of a mercaptan R₁-SH to the surface of a transition metal.

FIG. 2 illustrates calibration curves for a n-dodecyl mercaptan (NDM) removal study to determine the amount of residual/unreacted NDM from a known concentrated NDM solution.

FIG. 3A illustrates a kinetic analysis of n-dodecyl mercaptan (NDM) quenching by an AIBN-mediated radical reaction at 60° C. and at 120° C. and at different amounts of AIBN by measuring the decrease in the concentration of NDM in styrene-acrylonitrile copolymer grafted polyoxy polyol (SAN-POP) over time. FIG. 3B illustrates the same kinetic analysis of n-dodecyl mercaptan (NDM) quenching by measuring the percent removal of NDM over time.

FIG. 4A illustrates a kinetic analysis of n-dodecyl mercaptan (NDM) quenching by an AIBN-mediated radical reaction and a tBP-mediated reaction at 60° C. and at 120° C. and at different amounts of AIBN and tBP by measuring the decrease in the concentration of NDM in SAN-POP over time. FIG. 4B illustrates the same kinetic analysis of n-dodecyl mercaptan (NDM) quenching by measuring the percent removal of NDM over time.

FIG. 5 illustrates a kinetic analysis of n-dodecyl mercaptan (NDM) removal in the presence of AIBN as a radical initiator and copper wire by measuring the percent removal of NDM from SAN-POP over time.

### DETAILED DESCRIPTION

### Definitions

The following description is merely exemplary in nature and is in no way intended to limit the present disclosure or its application or uses.

As used herein, a mercaptan (also referred to as a thiol) refers to a sulfur-containing organic compound having a —SH functional group.

As used herein, a radical initiator refers to a chemical substance which easily decomposes into a free radical, which serves as a reactive intermediate in synthetic methodologies.

As used herein, a transition metal refers to a metallic element occupying a central block (Groups 3 to 12) in the periodic table.

As used herein, an azo compound refers to an organic chemical compound containing an azo group (—N═N—).

As used herein, an organic peroxide refers to an organic compound containing an oxygen-oxygen (—O—O—) bond.

The invention provides for the removal of mercaptan compounds present in a polymer composition, typically in only a residual amount. In an exemplary embodiment, the source of the mercaptan compound is as a chain transfer agent used in the preparation of the polymer, although the invention is not so limited and the mercaptan compound may be present in the polymer composition for any reason. One of the benefits achieved by the invention is the reduction or elimination from the polymer composition of the undesirable odors associated with mercaptan compounds.

### Polymers

Polymers suitable for treatment in the invention are not particularly limited, especially polymers that utilize mercaptan chain transfer agents, such as, but not limited to, acrylates, methacrylates, styrenics, and derivatives thereof. In an exemplary embodiment, the polymers have a viscosity in a range of 500 to 50,000 mPA·s, such as 1000 to 35,000 mPA·s, such as 2000 to 25,000 mPA·s, such as 3000 to 20,000 mPA·s, such as 3500 to 15,000 mPA·s, such as 4000 to 12,000, such as 4000 to 10,000, such as 4000 to 8000, such as 5000 to 10,000, such as 5000 to 8000.

In an exemplary embodiment, suitable polymers include, but are not limited to, grafted polymers, such as grafted polyol polymers (e.g., polyacrylonitrile grafted polyols and polyurea grafted polyols), grafted copolymers (e.g., a methyl methacrylate copolymer, a styrene copolymer, an acrylate copolymer), grafted polyol copolymers (e.g., a co-polymerized styrene-acrylonitrile grafted polyol (SAN-POP) and styrene-butadiene rubber (SBR), carboxylated styrene-butadiene latex (SB latex), acrylonitrile-butadiene-styrene (ABS) copolymer and polychloroprene (neoprene). In a particular embodiment, the polymer is SAN-POP.

In an exemplary embodiment, the polymer is any polymer prepared using a mercaptan chain transfer agent.

In an exemplary embodiment, the polymer is present in a polymer composition that further comprises one or more of unreacted monomer residues, surfactants, organic solvents and water.

### Radical Initiator

In general, conventional radical initiators are suitable for use in the present invention. In an exemplary embodiment, suitable radical initiators include, but are not limited to, peroxides (such as organic peroxides, including alkyl and aryl hydroperoxides, and alkyl and aryl peroxides), peresters, persulfates, percarbonates, Norish type I and II photoinitiators and azo compounds. Exemplary radical initiators include, but are not limited to, hydrogen peroxide, ammonium persulfate, potassium persulfate, sodium persulfate, potassium peroxymonosulfate, 2,2-dimethoxy-1,2-diphenyl-ethan-l-one, 1-hydroxycyclohexylphenyl-ketone, 2-hydroxy-2-methyl-1-phenylpropanone. Benzophenone, isopropyl thioxanthone, ethyl hydroperoxide, di-tert-butyl peroxide, tert-butyl hydroperoxide, tert-amyl hydroperoxide, benzoyl peroxide, methyl ethyl ketone peroxide, methyl isobutyl ketone peroxide, acetyl acetone peroxide, diacetyl peroxide, di(t-butyl) peroxide, tert-butylperoxy diethyl acetate, tert-butyl peroctoate, tert-butyl peroxy isobutyrate, 1,1-di(tert-butylperoxy)cyclohexane, tert-butyl peroxy 3,5,5-trimethyl hexanoate, tert-butyl perbenzoate, tert-butyl peroxy pivalate, tert-amyl peroxy pivalate, tert-butyl peroxy-2-ethyl hexanoate, 1,1-di(tert-amylperoxy)cyclohexane, lauroyl peroxide, cumene hydroperoxide, azobisisobutyronitrile (AIBN), 2,2′-azo bis-(2-methylbutyronitrile), 2,2′-azo bis-(2-methoxylbutyronitrile) and mixtures thereof. In a particular embodiment, the radical initiator is di-tert-butyl peroxide or AIBN.

The quantity of the radical initiator employed in the invention can be varied within wide limits. In an exemplary embodiment, the amount of radical initiator ranged from about 0.001% to 20% by weight, such as 0.005% to 15% by weight, such as 0.005% to 10% by weight, such as 0.01% to 10% by weight, based on 100% by weight of the polymer. It was observed that an increase in the amount of the radical initiator resulted in an increase in the removal/reduction of the mercaptan present in the polymer up to a certain point, but further increases did not result in a significant increase in reduction.

### Transition Metal

In general, any transition metal would be suitable for use in the present invention. In an exemplary embodiment, the transition metal includes, but is not limited to, titanium, chromium, manganese, copper, iron, zinc, cobalt, nickel, zirconium, silver, platinum and gold. In a particular embodiment, the transition metal is copper or gold.

The quantity of the transition metal employed in the invention can be varied within wide limits. In an exemplary embodiment, the amount of transition metal ranged from about 0.5% to 10.0% by weight, such as 1.0% to 8.0%, such as 2.0% to 7.0%, such as 3.0% to 7.0%, based on 100% by weight of the polymer. Alternatively, the amount of the transition metal may be measured using a surface-to-volume (S/V) ratio. In an exemplary embodiment, the S/V for the transition metal ranged from 0.03 cm⁻¹ to 0.6 cm⁻¹, such as 0.05 cm⁻¹ to 0.5 cm⁻¹, such as 0.07 cm⁻¹ to 0.4 cm⁻¹, such as 0.10 cm⁻¹ to 0.3 cm⁻¹. In a particular embodiment, the transitional metal was copper and the S/V ranged from 0.0628 cm⁻¹ (for a 1 cm piece of copper wire) to 0.314 cm⁻¹ (for a 5 cm piece of copper wire). It was observed that an increase in the amount of the transition metal resulted in an increase in the removal/reduction of the mercaptan present in the polymer up to a certain point, but further increases did not result in a significant increase in reduction.

The form of the transition metal is not particularly limited. Generally, forms that possess a large surface area are preferred. Suitable forms include, but are not limited to wire and wire mesh, plate, pipe and drum.

### Mercaptan

The mercaptan to be removed from the polymer composition is not particularly limited.

In an exemplary embodiment, the mercaptan compound is a C₄-C₁₆ alkyl mercaptan compound.

In a particular embodiment, the mercaptan is a chain transfer agent for use in polymer production.

Suitable mercaptans include, but are not limited to, all normal, branched and cyclic isomers of each of the following: hexyl mercaptan (hexanethiol), heptyl mercaptan (heptanethiol), octyl mercaptan (octanethiol), nonyl mercaptan (nonanethiol), decyl mercaptan (decanethiol), undecyl mercaptan (undecanethiol), dodecyl mercaptan (dodecanethiol), tridecyl mercaptan (tridecanethiol), tetradecyl mercaptan (tetradecanethiol), pentadecyl mercaptan (pentadecanethiol) and hexadecyl mercaptan (hexadecanethiol).

Other suitable mercaptans include, but are not limited to, thioglycolic acid, 1,8-dimercapto-3,6-dioxaoctane, 2-ethylhexyl thioglycolate, 1,2-ethane dithiol, 2,3-dimercaptopropanol, pyrithione, dithioerythritol, 3,4-dimercaptotoluene, 2,3-butanedithiol, 1,3-propanedithiol, 2-hydroxypropane thiol, 1-mercapto-2-propanol, dithioerythritol, dithiothreitol, ethane 2-propanethiol, tert-butyl mercaptan, cysteine, 2-mercaptoethanol, 2-mercaptoindole, 1,11-undecanedithiol, 1,16-hexadecanedithiol, 1,4-benzenedimethanethiol, 1,4-butanedithiol, 1,4-butanedithiol diacetate, 1,5-pentanedithiol, 1,6-hexanedithiol, 1,8-octanedithiol, 1,9-nonanedithiol, adamantanethiol, 1-mercapto-triethylene glycol, 1-mercapto-triethylene glycol methyl ether, 1-mercapto-2-propanol, 2,2′-(ethylenedioxy)diethanethiol, 2-ethylhexanethiol, 2-methyl-1-propanethiol, 2-methyl-2-propanethiol, 2-phenylethanethiol, 3-chloro-1-propanethiol, 3-mercapto-1-propanol, 3-mercapto-2-butanol, 3-mercapto-N-nonylpropionamide, 3-mercaptopropionic acid, 3-methyl-1-butanethiol, 4-cyano-1-butanethiol, 4-mercapto-1-butanol, 6-mercapto-1-hexanol, 6-mercaptohexanoic acid, 8-mercapto-1-octanol, 8-mercaptooctanoic acid, 9-mercapto-1-nonanol, biphenyl-4,4′-dithiol, butyl 3-mercaptopropionate, cyclohexanethiol, cyclopentanethiol, mercaptosuccinic acid, methyl 3-mercaptopropionate, PEG dithiol, S-(4-cyanobutyl)thioacetate and thiophenol.

In an exemplary embodiment, the mercaptan is present in the polymer in an amount of 0.001% to 10% by weight, such as 0.003% to 10% by weight, such as 0.005% to 8% by weight, such as 0.01% to 6% by weight, such as 0.05% to 3% by weight, based on 100% by weight of the polymer.

In an exemplary embodiment, the mercaptan is present in the polymer in a residual amount.

### Process

The process of the invention removes one or more mercaptans, typically present in a residual amount, from a polymer, chiefly for the purpose of deodorizing the polymer from the malodor associated with the mercaptans.

In various embodiments, the removal of the mercaptans occurs by (i) chemical, (ii) physical or (iii) a combination of chemical and physical quenching of the mercaptans. The process is not limited by the order of (i) and (ii), such that removal of the mercaptans may proceed first by chemical removal (i) followed by physical removal (ii) or alternatively, removal of the mercaptans may proceed first by physical removal (ii) followed by chemical removal (i). In an exemplary embodiment, the chemical quenching is conducted by the addition of one radical initiator or two or more radical initiators having different activation temperatures. The radical initiator forms a radical (R· or R₂·) which captures a labile proton from the polymer to generate a polymeric radical (Polymer·) or from the mercaptan to generate a thiyl radical (R₁—S·). The thiyl radical is capable of reacting with the polymeric radical to form a non-odorous compound (R₁-S-Polymer, i.e., sulfides). See Scheme 1.

Radical Initiator [symbol] R·

R·+Polymer-H [symbol] R—H+Polymer·

R₁—SH+R₂· [symbol] R₁—S·+R₂—H

R₁—S·+Polymer· [symbol] R₁—S-Polymer

Scheme 1. Chemical Quenching Mechanism for Deodorization of Mercaptans

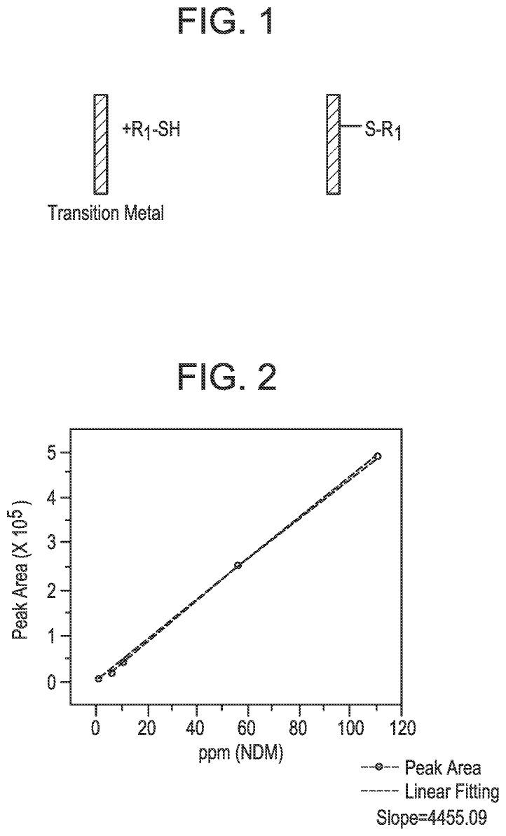

In an exemplary embodiment, physical quenching of the mercaptans occurs by a thiol-metal interaction where the mercaptans are captured by and adhere to a surface of the transition metal which effectively removes the malodor associated with the mercaptans. See FIG. 1. In an embodiment, the transition metal replaces a stainless steel mesh for filtering large aggregates of the polymer.

In an exemplary embodiment, the chemical and physicals methods of mercaptan removal were combined. In a particular embodiment of the combined methods, the radical initiator was di-tert-butyl peroxide, the transition metal was copper and the polymer was a SAN-POP.

In an exemplary embodiment, the chemical and physical quenching reactions are conducted at a temperature of between 50 and 150° C., such as between 60 and 130° C., such as between 70 and 120° C., such as between 70 and 100° C., such as between 80 and 90° C.

In an exemplary embodiment, the chemical and physical quenching reaction times range from 30 minutes to 15 hours, such as 1 hour to 10 hours, such as 3 hours to 8 hours.

In an exemplary embodiment, the chemical and physical quenching reactions are carried out under neat (no solvent) conditions. In another exemplary embodiment, the chemical and physical quenching are carried out in solvents that include, but are not limited to, alcohols (e.g., methanol, ethanol, isopropanol), ethers (e.g., tetrahydrofuran, dioxane), DMF, DMSO, methyl ethyl ketone, chloroform and dichloromethane.

In an exemplary embodiment, the chemical and/or physical quenching reactions of the present invention are employed in combination with one or more conventional processes of mercaptan removal.

Non-limiting aspects of this disclosure may be summarized below:

Aspect 1: A method for removing a mercaptan compound present in a polymer composition, comprising at least one of: contacting the polymer composition with a radical initiator that reacts with the mercaptan compound to form a non-odorous compound; and contacting the polymer composition with a transition metal that immobilizes the mercaptan compound.

Aspect 2: The method of Aspect 1, wherein the polymer composition comprises the polymer.

Aspect 3: The method of Aspect 1 or Aspect 2, wherein the polymer composition consists essentially of the polymer.

Aspect 4: The method of any of Aspects 1-3, wherein the polymer composition consists of the polymer.

Aspect 5: The method of any of Aspects 1-4, wherein the polymer is a polymer grafted polyol.

Aspect 6: The method of any of Aspects 1-5, wherein the polymer grafted polyol is selected from the group consisting of a co-polymerized styrene-acrylonitrile grafted polyol (SAN-POP), a polyacrylonitrile grafted polyol and a polyurea grafted polyol.

Aspect 7: The method of any of Aspects 1-6, wherein the polymer is a co-polymerized styrene-acrylonitrile grafted polyol (SAN-POP).

Aspect 8: The method of any of Aspects 1-7, wherein the polymer is a co-polymerized styrene-acrylonitrile grafted polyol.

Aspect 9: The method of any of Aspects 1-8, wherein the polymer has a viscosity in a range of 500 to 50,000 mPA·s.

Aspect 10: The method of any of Aspects 1-9, wherein the radical initiator is selected from the group consisting of organic peroxides, persulfates and azo compounds.

Aspect 11: The method of any of Aspects 1-10, wherein the radical initiator is an aliphatic azo compound.

Aspect 12: The method of any of Aspects 1-11, wherein the radical initiator is selected from the group consisting of ethyl hydroperoxide, di-tert-butyl peroxide, tert-butyl hydroperoxide, tert-amyl hydroperoxide, benzoyl peroxide, methyl ethyl ketone peroxide, methyl isobutyl ketone peroxide, acetyl acetone peroxide, diacetyl peroxide and mixtures thereof.

Aspect 13: The method of any of Aspects 1-12, wherein the radical initiator is azobisisobutyronitrile (AIBN) or di-tert-butyl peroxide.

Aspect 14: The method of any of Aspects 1-13, wherein the transition metal is selected from the group consisting of titanium, chromium, manganese, copper, iron, zinc, cobalt, nickel, zirconium, silver, platinum and gold.

Aspect 15: The method of any of Aspects 1-14, wherein the transition metal is copper.

Aspect 16: The method of any of Aspects 1-15, wherein the method comprises contacting the polymer composition with a radical initiator that reacts with the mercaptan compound to form a non-odorous compound.

Aspect 17: The method of any of Aspects 1-16, wherein the method consists of contacting the polymer composition with a radical initiator that reacts with the mercaptan compound to form a non-odorous compound.

Aspect 18: The method of any of Aspects 1-17, wherein the method comprises contacting the polymer composition with a transition metal that immobilizes the mercaptan compound.

Aspect 19: The method of any of Aspects 1-18, wherein the method consists of contacting the polymer composition with a transition metal that immobilizes the mercaptan compound.

Aspect 20: The method of any of Aspects 1-19, wherein the method comprises contacting the polymer composition with a radical initiator that reacts with the mercaptan compound to form a non-odorous compound; and contacting the polymer composition with a transition metal that immobilizes the mercaptan compound.

Aspect 21: The method of any of Aspects 1-20, wherein the method consists of contacting the polymer composition with a radical initiator that reacts with the mercaptan compound to form a non-odorous compound; and contacting the polymer composition with a transition metal that immobilizes the mercaptan compound.

Aspect 22: The method of any of Aspects 1-21, wherein the polymer composition is contacted with the radical initiator before being contacted with the transition metal.

Aspect 23: The method of any of Aspects 1-22, wherein the polymer composition is contacted with the transition metal before being contacted with the radical initiator.

Aspect 24: The method of any of Aspects 1-23, wherein the polymer composition is contacted with the radical initiator and the transition metal at the same time.

Aspect 25: The method of any of Aspects 1-24, wherein the polymer composition and the radical initiator are maintained together at a temperature between 50 and 150° C.

Aspect 26: The method of any of Aspects 1-25, wherein the polymer composition and transition metal are maintained together at a temperature between 50 and 150° C.

Aspect 27: The method of any of Aspects 1-26, wherein the mercaptan compound is present in a residual amount from a prior step to prepare the polymer composition.

Aspect 28: The method of any of Aspects 1-27, wherein, the mercaptan compound is a C₄-C₁₆ alkyl mercaptan compound.

Aspect 29: The method of any of Aspects 1-28, wherein the mercaptan compound is a chain transfer agent.

Aspect 30: The method of any of Aspects 1-29, wherein the mercaptan is selected from the group consisting of all normal, branched and cyclic isomers of each of the following: hexyl mercaptan (hexanethiol), heptyl mercaptan (heptanethiol), octyl mercaptan (octanethiol), nonyl mercaptan (nonanethiol), decyl mercaptan (decanethiol), undecyl mercaptan (undecanethiol), dodecyl mercaptan (dodecanethiol), tridecyl mercaptan (tridecanethiol), tetradecyl mercaptan (tetradecanethiol), pentadecyl mercaptan (pentadecanethiol) and hexadecyl mercaptan (hexadecanethiol).

Aspect 31: The method of any of Aspects 1-30, the mercaptan is n-dodecyl mercaptan (n-dodecanethiol).

Aspect 32: The method of any of Aspects 1-29, wherein the mercaptan is selected from the group consisting of thioglycolic acid, 1,8-dimercapto-3,6-dioxaoctane, 2-ethylhexyl thioglycolate, 1,2-ethane dithiol, 2,3-dimercaptopropanol, pyrithione, dithioerythritol, 3,4-dimercaptotoluene, 2,3-butanedithiol, 1,3-propanedithiol, 2-hydroxypropane thiol, 1-mercapto propanol, dithioerythritol, dithiothreitol, ethane 2-propanethiol, tert-butyl mercaptan, cysteine, 2-mercaptoethanol, 2-mercaptoindole, 1,11-undecanedithiol, 1,16-hexadecanedithiol, 1,4-benzenedimethanethiol, 1,4-butanedithiol, 1,4-butanedithiol diacetate, 1,5-pentanedithiol, 1,6-hexanedithiol, 1,8-octanedithiol, 1,9-nonanedithiol, adamantanethiol, 1-mercapto-triethylene glycol, 1-mercapto-triethylene glycol methyl ether, 1-mercapto-2-propanol, 2,2′-(ethylenedioxy)diethanethiol, 2-ethylhexanethiol, 2-methyl-1-propanethiol, 2-methyl-2-propanethiol, 2-phenylethanethiol, 3-chloro-1-propanethiol, 3-mercapto-1-propanol, 3-mercapto-2-butanol, 3-mercapto-N-nonylpropionamide, 3-mercaptopropionic acid, 3-methyl-1-butanethiol, 4-cyano-l-butanethiol, 4-mercapto-1-butanol, 6-mercapto-1-hexanol, 6-mercaptohexanoic acid, 8-mercapto-1-octanol, 8-mercaptooctanoic acid, 9-mercapto-1-nonanol, biphenyl-4,4′-dithiol, butyl 3-mercaptopropionate, cyclohexanethiol, cyclopentanethiol, mercaptosuccinic acid, methyl 3-mercaptopropionate, PEG dithiol, S-(4-cyanobutyl)thioacetate and thiophenol.

Aspect 33: A method for deodorizing a mercaptan odor from a polymer composition, comprising at least one of: contacting the polymer composition with a radical initiator that reacts with a mercaptan compound to form a non-odorous compound; and contacting the polymer composition and a transition metal that immobilizes a mercaptan compound, where any of Aspects 1-31 apply.

Aspect 34: The method of any of Aspects 1-33, wherein the chemical and/or physical quenching reactions of the present invention are employed in combination with one or more conventional processes of mercaptan removal.

### EXAMPLES

### Example 1

### Preparation of Gas Chromatography (GC) Calibration Curves for Determining Amount of Residual/Unreacted n-Dodecyl Mercaptan (NDM) from Known Concentrated NDM Solution

Two master solutions (MS1 and MS2) were prepared as follows:
(i) MS1: 0.5047 grams of NDM was dissolved in isooctane, where the total weight was 10.02 grams (target: 100 ppm NDM; actual: 104.5 ppm).
(ii) MS2: 0.2542 gram of NDM was dissolved in isooctane, where the total weight was 10.00 grams (target: 50 ppm; actual: 52.25 ppm).
   Using MS1 and MS2, standard samples of 10.45, 5.23, 1.05 and 0.52 ppm were prepared and measured by gas chromatography (GC) with mass spectroscopy (GC-MS) in order to analyze retention times and isotope patterns (confirming NDM from the detected peak). In general, NDM peaks were found 6.15-6.20 min. Based on the peak areas (measured five times), calibration curves were prepared. See FIG. 1. Based on the calibration curves, the original concentration of NDM in SAN-POP was determined to be 10.45 (12.13% error).

### Example 2

### General Procedure for Radical Reaction

5 grams of a SAN-POP mixture were placed in a 20 ml glass vial and purged with nitrogen (N₂) in order to remove oxygen. 4 mg or 8 mg of azobisisobutyronitrile (AIBN) or di-tert-butyl peroxide (tBP) as a radical initiator and a magnetic bar stirrer (rare-earth stirrer bar for sufficient stirring under high viscosity) were added to the vial. The reaction was stirred at a temperature of 60 or 120° C. Samples were taken periodically and measured by GC-MS to determine the amount of NDM.

### Example 3

### General Procedure for Physical Immobilization

Copper (or gold) wire was gently washed with diluted hydrochloric acid (HCI) to remove any surface debris, and then washed with copious amounts of water and methanol, sequentially. The wire was dried by N₂ blowing and then placed in a clean 20 ml vial. Up to 5 grams of a SAN-POP solution and a magnetic bar stirrer (rare-earth stirrer bar) were added to the vial and purged by N₂. The reaction was stirred at a temperature of 60 or 120° C. Samples were taken periodically and measured by GC-MS to determine the amount of NDM.

### Example 4

### General Procedure for Chemical and Physical Quenching

Copper (or gold) wire (diameter=1 mm and length=1 or 5 cm) was gently washed with diluted hydrochloric acid (HCl) to remove any surface debris and then washed with copious amounts of water and methanol, sequentially. The wire was dried by N₂ blowing and placed in a clean 20 ml vial. Up to 5 grams of a SAN-POP solution, 4 or 8 mg of a radical initiator and a magnetic bar stirrer (rare-earth stirrer bar) were added to the vial and purged by N₂. The reaction was stirred at a temperature of 60 or 120° C. Samples were taken periodically and measured by GC-MS to determine the amount of NDM.

### Example 5

### Quenching Results

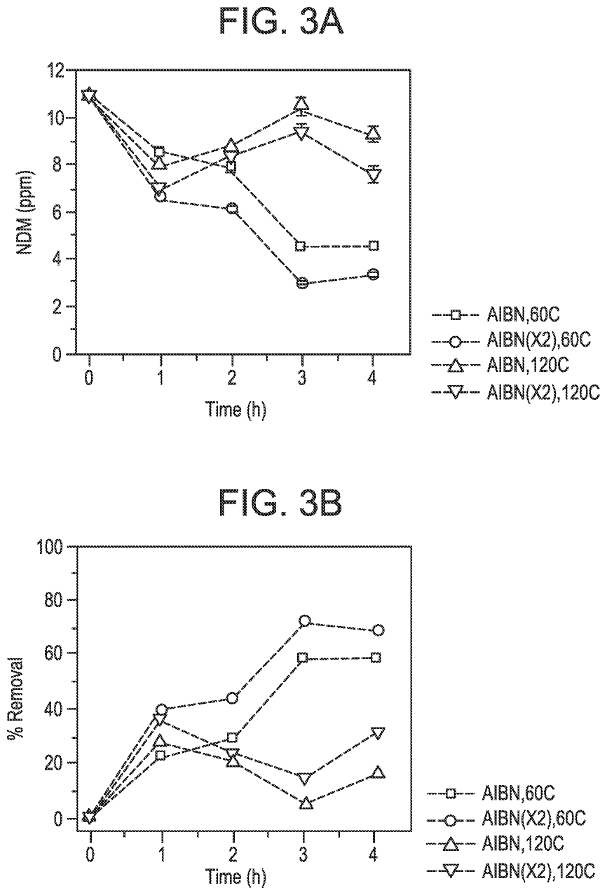

Overnight reaction of the radical quenching reaction was carried out using 5.02 grams of SAN-POP and 3.8 mg of AIBN under 60° C. The result indicated that up to 87% (8% error) of NDM was removed/quenched using the radical quenching process. Detailed kinetic studies were conducted by evaluating radical initiator concentration and temperature effects. See FIG. 2. In general, it was observed that a higher radical concentration more quickly reduced the amount of residual NDM. However, it was also observed that AIBN is not a suitable radical initiator at elevated temperatures (i.e., at 120° C.) because the rate of dissociation of the radical source resulted in a too rapid consumption of radicals. To overcome this problem of operating at elevated reaction temperatures, tBP was selected as the radical initiator in view of its 10-hour half-life time at 125° C. Compared to AIBN, tBP exhibited better efficiency in quenching NDM. See FIG. 3.

Physical immobilization experiments were conducted in the presence of copper and gold wires: overnight reactions at a temperature of 60° C. Approximately 19.36% (7% error) of NDM removal was observed in the presence of copper wire, whereas approximately 6.36% (3% error) of NDM removal was observed in the presence of gold wire. These yields were lower than the yields obtained with the (chemical) radical reactions.

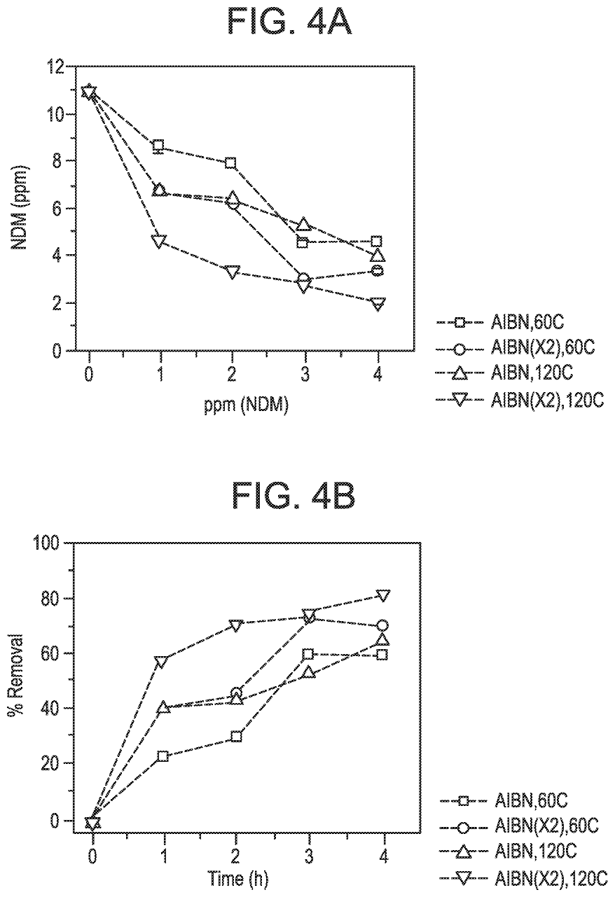

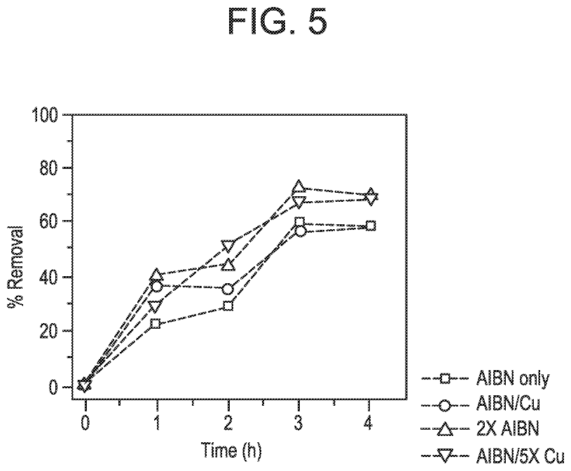

A combination of the (chemical) radical quenching and physical immobilization experiments were carried out as follows: AIBN (4 or 8 mg) was selected as a radical source and copper wire (diameter=1 mm and length=1 or 5 cm) was selected as a transition metal source and the reaction temperature was 60° C. Kinetic studies indicated that a higher amount of copper wire improved the removal of NDM from SAN-POP. Thus, although a combination of 1 cm of copper wire +AIBN did not show a significant improvement in NDM removal, the use of 5× excess copper wire in combination with AIBN showed a NDM removal efficiency similar to that of 2× AIBN (FIG. 4).

Table 1 below summarizes NDM removal using the radical initiators AIBN or tBP alone or in combination with copper wire as a transition metal. All listed weight percentages are relative to the total weight percent of the polymer.

TABLE 1

| | | | | Reaction | |
|---|---|---|---|---|---|
| | | Copper | Reaction | Temperature | % |
| Entry | Initiator | Wire | Time | (±10° C.) | Removal |
| 1 | AIBN | None | 4 hours | 60° C. | 58 |
| | (0.08 wt %) | | | | |
| 2 | AIBN (X2) | None | 4 hours | 60° C. | 69 |
| | (0.16 wt %) | | | | |
| 3 | tBP | None | 4 hours | 120° C. | 64 |
| | (0.08 wt %) | | | | |
| 4 | tBP (X2) | None | 4 hours | 120° C. | 81 |
| | (0.16 wt %) | | | | |
| 5 | AIBN | 1 cm | 4 hours | 60° C. | 58 |
| | (0.08 wt %) | (d = 1 mm) | | | |
| | | (1.5 wt %) | | | |
| 6 | AIBN | 5 cm | 4 hours | 60° C. | 68 |
| | (0.08 wt %) | (d = 1 mm) | | | |
| | | (7.0 wt %) | | | |

The results in Table 1 show that the highest % removal of NDM occurred with tBP (X2). Good results occurred with AIBN (X2) and AIBN+Cu (X5).

All publications referred to herein are incorporated by reference in their entireties.

Within this specification embodiments have been described in a way which enables a clear and concise specification to be written, but it is intended and will be appreciated that embodiments may be variously combined or separated without departing from the invention. For example, it will be appreciated that all preferred features described herein are applicable to all aspects of the invention described herein.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to produce the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. A method for removing a mercaptan compound present in a polymer composition, comprising at least one of:
contacting the polymer composition with a radical initiator that reacts with the mercaptan compound to form a non-odorous compound; and
contacting the polymer composition with a transition metal that immobilizes the mercaptan compound.

2. The method according to claim 1, wherein the polymer is a polymer grafted polyol.

3. The method according to claim 2, wherein polymer grafted polyol is selected from the group consisting of a co-polymerized styrene-acrylonitrile grafted polyol (SAN-POP), a polyacrylonitrile grafted polyol and a polyurea grafted polyol.

4. The method according to claim 1, wherein the polymer is a co-polymerized styrene-acrylonitrile grafted polyol.

5. The method according to claim 1, wherein the polymer has a viscosity in a range of 500 to 50,000 mPA·s.

6. The method according to claim 1, wherein the radical initiator is selected from the group consisting of organic peroxides and azo compounds.

7. The method according to claim 1, wherein the radical initiator is an aliphatic azo compound.

8. The method according to claim 1, wherein the radical initiator selected from the group consisting of ethyl hydroperoxide, di-tert-butyl peroxide, tert-butyl hydroperoxide, tert-amyl hydroperoxide, benzoyl peroxide, methyl ethyl ketone peroxide, methyl isobutyl ketone peroxide, acetyl acetone peroxide, diacetyl peroxide and mixtures thereof.

9. The method according to claim 1, wherein the radical initiator is azobisisobutyronitrile (AIBN) or di-tert-butyl peroxide.

10. The method according to claim 1, wherein the transition metal is selected from the group consisting of titanium, chromium, manganese, copper, iron, zinc, cobalt, nickel, zirconium, silver, platinum and gold.

11. The method according to claim 1, wherein the transition metal is copper.

12. The method according to claim 1, comprising:
contacting the polymer composition with a radical initiator that reacts with the mercaptan compound to form a non-odorous compound.

13. The method according to claim 1, consisting of:
contacting the polymer composition with a radical initiator that reacts with the mercaptan compound to form a non-odorous compound.

14. The method according to claim 1, comprising:
contacting the polymer composition with a transition metal that immobilizes the mercaptan compound.

15. The method according to claim 1, consisting of:
contacting the polymer composition with a transition metal that immobilizes the mercaptan compound.

16. The method according to claim 1, comprising:
contacting the polymer composition with a radical initiator that reacts with the mercaptan compound to form a non-odorous compound; and
contacting the polymer composition with a transition metal that immobilizes the mercaptan compound.

17. The method according to claim 1, consisting of:
contacting the polymer composition with a radical initiator that reacts with the mercaptan compound to form a non-odorous compound; and
contacting the polymer composition with a transition metal that immobilizes the mercaptan compound.

18. The method according to claim 16, where the polymer composition is contacted with the radical initiator before being contacted with the transition metal.

19. The method according to claim 16, where the polymer composition is contacted with the transition metal before being contacted with the radical initiator.

20. The method according to claim 16, wherein the polymer composition is contacted with the radical initiator and the transition metal at the same time.

21. The method according to claim 1, wherein the polymer composition and the radical initiator are maintained together at a temperature between 50 and 150° C.

22. The method according to claim 1, wherein the polymer composition and transition metal are maintained together at a temperature between 50 and 150° C.

23. The method according to claim 1, wherein the mercaptan compound is present in a residual amount from a prior step to prepare the polymer composition.

24. The method according to claim 1, wherein the mercaptan compound is a C₄-C₁₆ alkyl mercaptan compound.

25. The method of claim 1, wherein the mercaptan compound is a chain transfer agent.

26. A method for deodorizing a mercaptan odor from a polymer composition, comprising at least one of:
contacting the polymer composition with a radical initiator that reacts with a mercaptan compound to form a non-odorous compound; and
contacting the polymer composition and a transition metal that immobilizes a mercaptan compound.
